(19) United States
(12) Patent Application Publication
(10) Pub. No.: US 2010/0205993 A1
(43) Pub. Date: Aug. 19, 2010

(54) HEAT EXCHANGER ARRANGED IN CEILING-BURIED AIR CONDITIONER AND CEILING-BURIED AIR CONDITIONER

(75) Inventors: Takuya Matsuda, Tokyo (JP); Akira Ishibashi, Tokyo (JP); Masanori Aoki, Tokyo (JP); Makoto Saito, Tokyo (JP); Sangmu Lee, Tokyo (JP)

Correspondence Address: BUCHANAN, INGERSOLL & ROONEY PC, POST OFFICE BOX 1404, ALEXANDRIA, VA, 22313-1404, US

(73) Assignee: MITSUBISHI ELECTRIC CORPORATION, TOKYO (JP)

(21) Appl. No.: 12/738,942

(22) PCT Filed: Jan. 20, 2009
(86) PCT No.: PCT/JP2009/050702

§ 371 Date: Apr. 20, 2010

(30) Foreign Application Priority Data
Feb. 20, 2008 (JP) 2008-038972

(51) Int. Cl. F25D 23/12; G06F 1/20

(52) U.S. Cl. 62/259.1; 165/181; 165/121

(57) ABSTRACT

A heat exchanger 100 has plate fins 1 laminated at an interval and a heat transfer pipe 2 inserted perpendicularly to the fins formed by a plurality of straight pipe portions 2s and a curved pipe portion 2r communicating end portions thereof with each other. In the plate fin 1, a first slit fin 3a protruding to the side of one face or the like and a second slit fin 3b protruding to the side of the other face or the like are formed by cutting and raising. A straight pipe portion 21a and the like are arranged in a zigzag state in parallel with each other, and a “step pitch Dp”, which is an interval between axial cores thereof in a step direction, and a “row pitch Lp”, which is an interval in a row direction, form relationships of “4 mm≦D≦6 mm, 14 mm≦Dp≦17 mm, 7 mm≦Lp≦10 mm” to an outer diameter D of the heat transfer pipe 2.

### TECHNICAL FIELD

The present invention relates to a heat exchanger arranged in a ceiling-buried air conditioner and a ceiling-buried air conditioner, and more particularly to a heat exchanger arranged in a fin-tube type ceiling-buried air conditioner for performing heat exchange between a refrigerant and a fluid such as a gas, and a ceiling-buried air conditioner using the heat exchanger arranged in the ceiling-buried air conditioner and the like.

### BACKGROUND ART

The prior-art fin-tube type heat exchanger is constructed by a plurality of plate fins arranged in parallel with each other at a predetermined interval and a meandering heat transfer pipe penetrating the plate fins in a normal direction, and heat exchange is performed between the air flowing between the plate fins and the refrigerant flowing inside the heat transfer pipe.

Recently, reduction in consumption energy of an air conditioner and a refrigerant amount used as a working fluid has been in strong demand in view of prevention of global warming, and higher performances and reduction in capacity are requested for the heat exchanger equipped in the equipment.

On the other hand, since a passing air velocity of gas is kept low in view of suppression of noise increase in order to secure comfortableness, heat conductivity on the air side is kept lower than the heat conductivity inside the heat transfer pipe. Thus, improvement of heat transfer on the air side has been promoted by increasing a heat transfer area on the air side.

That is, due to the demand for size reduction of the heat exchanger or limitation on an installation space, instead of increasing a heat transfer area by increasing the size of the heat exchanger by increasing the number of installations of air-flow direction (step direction) of the heat exchanger and extending a length of the heat transfer pipe in the lamination direction of the plate fins (equal to the length of a straight pipe portion), a method of increasing the heat transfer area of the heat exchanger by reducing a diameter of the heat transfer pipe, narrowing a fin pitch or increasing the number of installation rows in the row direction of the heat transfer pipe is employed. For example, a heat exchanger with the heat transfer pipe diameter of approximately 10 mm and the fin pitch of up to approximately 1.5 mm or the number of rows of 2 was commercialized before, but in a recently commercialized heat exchanger, the heat transfer pipe diameter is reduced up to approximately 7 mm and the fin pitch to approximately 1.1 mm, and the number of rows is 3 or more.

An invention is disclosed (See Patent Document 1, for example) in which heat transfer performance is improved by setting a heat transfer pipe outer diameter D in a range of

3 mm≦D≦7.5 mm, and

1.2D≦Lp≦1.8D

2.6D≦Dp≦3.5D

where Lp: a row pitch of the heat transfer pipe in a gas passing direction; and

Dp: a step pitch of the heat transfer pipe in a direction (step direction) orthogonal to the gas passing direction, and moreover, slit fin rows projecting on both faces of the plate fin are formed by “cutting and raising” of a plurality of rows in the step direction orthogonal to the gas passing direction so that improvement of the heat transfer performance and mixing of the gas in the cut and raised portion are promoted (See Patent Document 1, for example).

[Patent Document 1] Japanese Unexamined Patent Application Publication No. 63-3188 (pages 2 to 3, FIG. 4)

### DISCLOSURE OF INVENTION

### Problems to be Solved by the Invention

However, Patent Document 1 does not refer to a type of the air conditioner in which the heat exchanger is installed. For example, in the ceiling-buried air conditioner, a proportion of pressure loss of the heat exchanger to total pressure loss of an air flow is approximately 50%, and even if the pressure loss of the heat exchanger of the air flow is increased, there is little problem to increase a blower operating power and a noise value. Therefore, if the heat exchanger is arranged in the ceiling-buried air conditioner, importance in design should be placed not on a ventilation resistance of the heat exchanger but on heat transfer performance.

Moreover, if the heat transfer pipe diameter is reduced, since a refrigerant pressure loss is increased with the increase in a refrigerant flow velocity in the heat transfer pipe, there is a problem that a heat exchange amount as an evaporator is reduced.

The present invention is made in order to solve the above problems and has an object to provide a “heat exchanger arranged in a ceiling-buried air conditioner” and a “ceiling-buried air conditioner” using a “heat exchanger arranged in a ceiling-buried air conditioner” with high heat transfer performance.

### Means for Solving the Problems

A heat exchanger arranged in a ceiling-buried air conditioner according to the present invention is characterized in that:

a plurality of plate fins laminated in parallel with each other at a predetermined interval so that a gas passes through the interval and a heat transfer pipe penetrating while meandering through the plate fins and through which a working fluid passes are provided, and

relationships among an outer diameter (D) of the heat transfer pipe, a step pitch (Dp), which is a distance between coaxial cores of the heat transfer pipe in a step direction orthogonal to a gas passing direction, and a row pitch (Lp), which is a distance between coaxial cores of the heat transfer pipe in a row direction, which is the gas passing direction is:

4 mm≦D≦6 mm

14 mm≦Dp≦17 mm

7 mm≦Lp≦10 mm.

### ADVANTAGES

Since the heat exchanger arranged in the ceiling-buried air conditioner according to the present invention is adapted to have the outer diameter (D) of the heat transfer pipe of “4 mm≦D≦6 mm”, the step pitch (Dp) of the heat transfer pipe of “14 mm≦Dp≦17 mm”, and the row pitch (Lp) in the row direction of the heat transfer pipe of “7 mm≦Lp≦10 mm”, the “heat exchanger arranged in the ceiling-buried air conditioner” with high heat transfer performance can be obtained.

### BRIEF DESCRIPTION OF DRAWINGS

FIG. 1 is a plan view illustrating a portion for explaining a heat exchanger arranged in a ceiling-buried air conditioner according to Embodiment 1 of the present invention.

FIG. 2 is a sectional view on front for explaining the heat exchanger shown in FIG. 1.

FIG. 3 is a sectional view for explaining the heat exchanger shown in FIG. 1.

FIG. 4 is a perspective view for explaining a concept of a ceiling-buried air conditioner according to Embodiment 2 of the present invention.

FIG. 5 is a sectional view for explaining a concept of the ceiling-buried air conditioner shown in FIG. 4.

FIG. 6 is a correlation diagram illustrating an influence of a heat transfer pipe diameter D on a heat exchanger performance index in the heat exchanger arranged in the ceiling-buried air conditioner shown in FIG. 1.

FIG. 7 is a correlation diagram illustrating an influence of a step pitch Dp on a heat exchanger performance index in the heat exchanger arranged in the ceiling-buried air conditioner shown in FIG. 1.

FIG. 8 is a correlation diagram illustrating an influence of a row pitch Lp on a heat exchanger performance index in the heat exchanger arranged in the ceiling-buried air conditioner shown in FIG. 1.

FIG. 9 is a correlation diagram illustrating an influence of a fin pitch Fp on a heat exchanger performance index in the heat exchanger arranged in the ceiling-buried air conditioner shown in FIG. 1.

FIG. 10 is a plan view illustrating a portion for explaining a heat exchanger arranged in a ceiling-buried air conditioner according to Embodiment 3 of the present invention.

FIG. 11 is a sectional view on front for explaining the heat exchanger shown in FIG. 10.

FIG. 12 is a plan view illustrating a portion for explaining a heat exchanger arranged in a ceiling-buried air conditioner according to Embodiment 4 of the present invention.

FIG. 13 is a sectional view for explaining a heat exchanger shown in FIG. 12.

FIG. 14 is a correlation diagram for explaining an effect of a slit fin in the heat exchanger shown in FIG. 6 or the like.

FIG. 15 is a correlation diagram for explaining an effect of the slit fin in the heat exchanger shown in FIG. 6 or the like.

FIG. 16 is a bottom view for explaining a concept of a ceiling-buried air conditioner according to Embodiment 5 of the present invention.

FIG. 17 is a partial sectional view for explaining a concept of a ceiling-buried air conditioner shown in FIG. 16.

### BEST MODES FOR CARRYING OUT THE INVENTION

### Embodiment 1

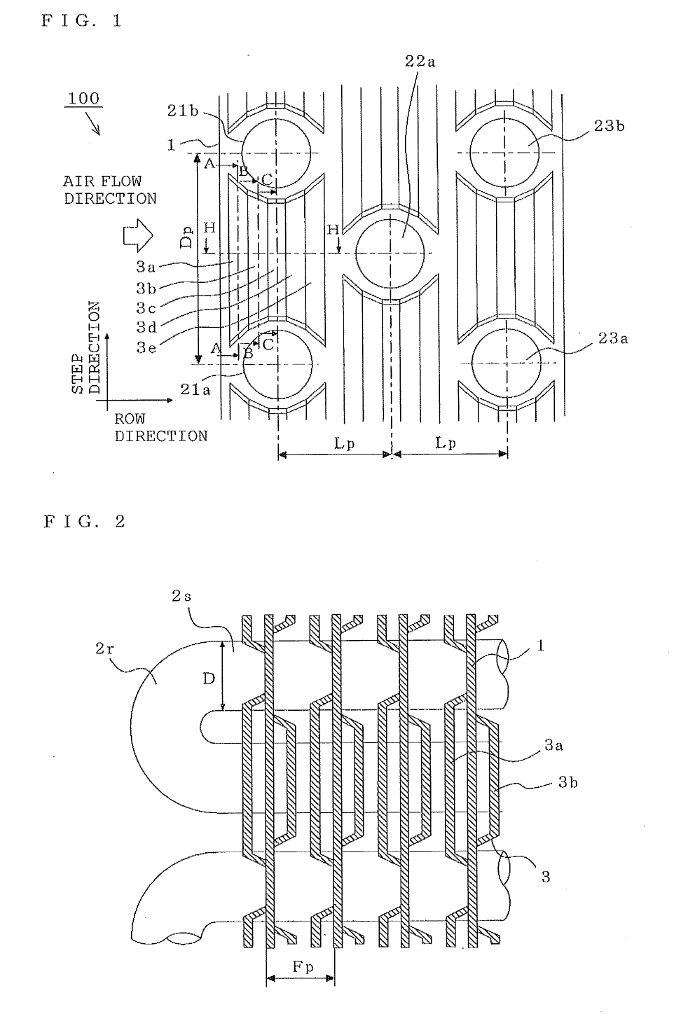

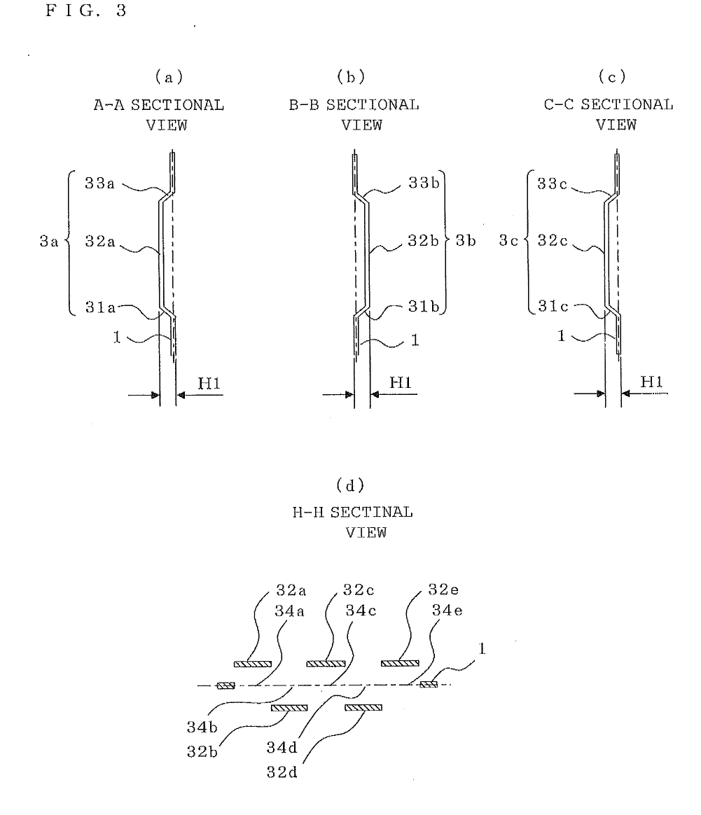

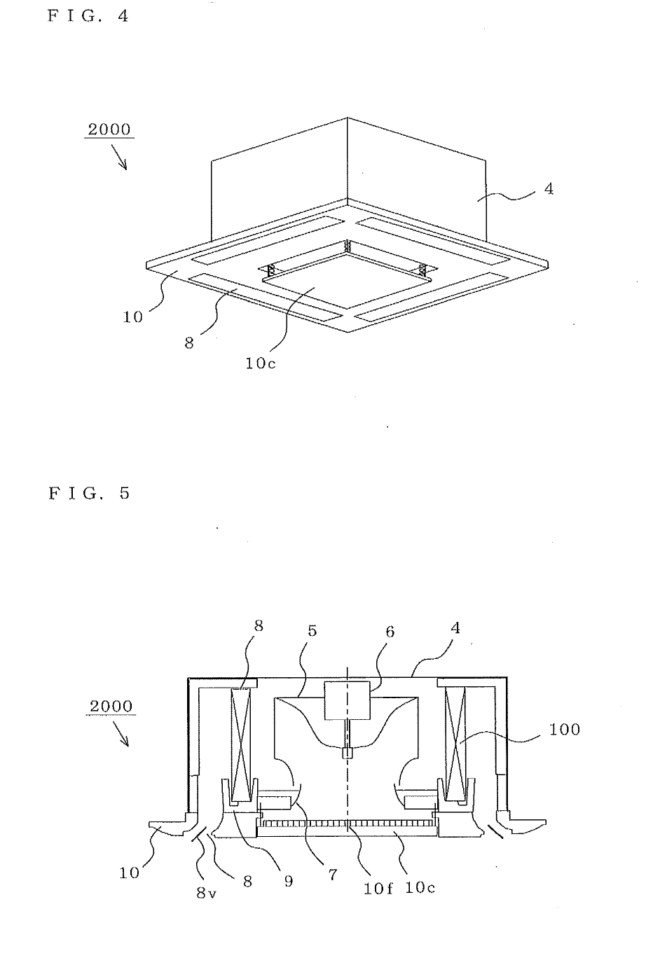

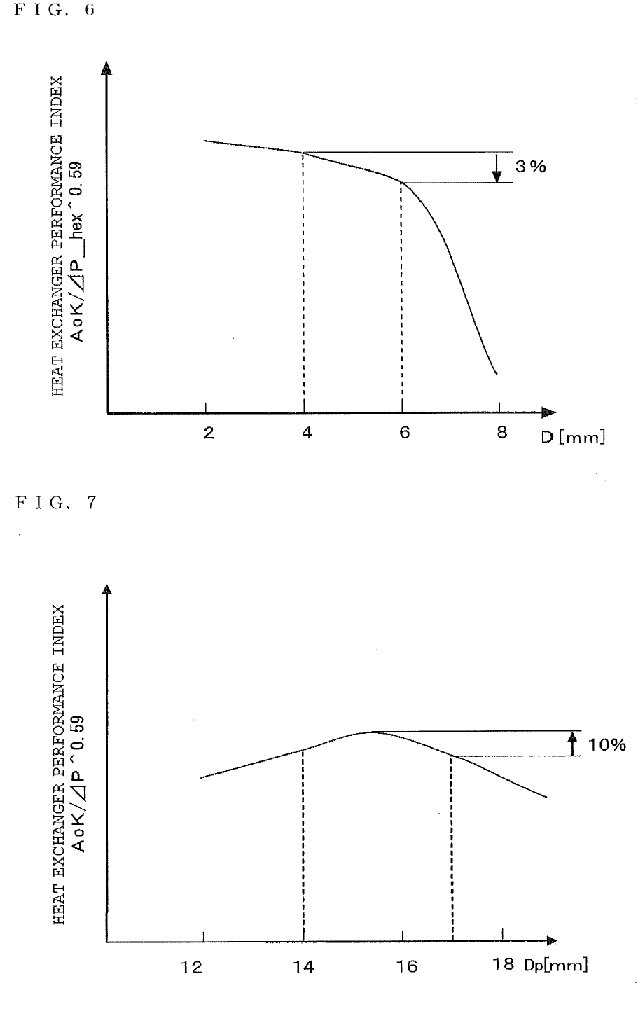

FIGS. 1 and 2 explain a heat exchanger arranged in a ceiling-buried air conditioner according to Embodiment 1 of the present invention, in which FIG. 1 is a plan view illustrating a portion, FIG. 2 is a sectional view on front, FIG. 3(a) is a sectional view of an A-A section in FIG. 1, FIG. 3(b) is a sectional view of a B-B section in FIG. 1, FIG. 3(c) is a sectional view of a C-C section in FIG. 1, and FIG. 3(d) is a sectional view of an H-H section in FIG. 1. In the following explanation, for those referring to the common contents, descriptions of suffixes “a, b, c, . . . ” will be omitted.

In FIGS. 1 and 2, a heat exchanger (hereinafter referred to as a “heat exchanger”) 100 arranged in a ceiling-buried air conditioner has a plurality of plate fins 1 laminated in parallel with each other at a predetermined interval, through which air passes, and a heat transfer pipe 2 inserted perpendicularly to the plate fins 1 and meandering, and a slit fin 3 is formed by cutting and raising on the plate fins 1.

(Heat Transfer Pipe)

In FIG. 1, the heat transfer pipe 2 is formed by a plurality of straight pipe portions 2s and a plurality of curved pipe portions 2r for having end portions of the straight pipe portions 2s communicate with each other. Straight pipe portions 21a, 21b, which are a part of the straight pipe portions 2s are arranged in a direction orthogonal to an air flow direction (hereinafter referred to as a “step direction”), and actually, straight pipe portions 21c, . . . (not shown) are arranged in the step direction. Similarly, straight pipe portions 22a . . . and straight pipe portions 23a, 23b, . . . , which are a part of the straight pipe portions 2s are arranged in the step direction, respectively. Since the air flow direction is referred to as a “row direction”, only three rows of the straight pipe portions 2s are arranged in the heat exchanger 100.

The straight pipe portions 21a, 21b, . . . , the straight pipe portions 22a, . . . , and the straight pipe portions 23a, 23b, . . . , are arranged in a zigzag state and in parallel with each other, and the “step pith Dp”, which is an interval in the step direction between the axial cores, and the “row pitch Lp”, which is an interval in the row direction, have a relationship of “4 mm≦D≦6 mm, 14 mm≦Dp≦17 mm, 7 mm≦Lp≦10 mm” to the outer diameter D of the heat transfer pipe 2, and D=5 mm, Dp=15.3 mm, and Lp=8.67 mm, for example.

(Plate Fin)

In FIGS. 1 to 3, the plate fin 1 is a rectangular plate material, and a plurality of through holes through which the straight pipe portions 2s of the heat transfer pipe 2 penetrate are formed in a zigzag state.

Moreover, between the straight pipe portion 21a and the straight pipe portion 21b, first slit fins 3a, 3c, 3e protruding to the side of one of the faces and second slit fins 3b, 3d protruding to the side of the other face are formed, respectively.

The first slit fins 3a, 3c, 3e are formed by cutting and raising the plate fin 1 to the side of one face and have first slit fin planes 32a, 32c, 32e, first slit fin slopes 31a, 31c, 31e supporting them, and first slip fin slopes 33a, 33c, 33e. Therefore, in the plate fin 1, first slit fin grooves 34a, 34c, 34e are formed by such cutting and raising.

Similarly, the second slit fins 3b, 3d are also formed by cutting and raising the plate fin 1 to the side of the other face and have second slit fin planes 32b, 32d, second slit fin slopes 31b, 31d supporting them, and second slit fin slopes 33b, 33d. Therefore, in the plate fin 1, second slit fin grooves 34b, 34d are formed by such cutting and raising.

The first slit fin groove 34a and the second slit fin groove 34b, the second slit fin groove 34b and the first slit fin groove 34c, the first slit fin groove 34c and the second slit fin groove 34d, and the second slit fin groove 34d and the first slit fin groove 34e continue each other, respectively. Therefore, a large hole is formed in a range of the plate fin 1 between the straight pipe portion 21a and the straight pipe portion 21b.

A protruding height (H1) of the first slit fins 3a, 3c, 3e from one of the faces of the plate fin 1 and a protruding height (H2) of the second slit fins 3b, 3d from the other face of the plate fin 1 are ⅓ of the fin pitch (Fp), which is a planar interval of the plate fin 1, that is, “H1=Fp/3, H2=Fp/3”.

### Embodiment 2

FIG. 4 explains a concept of a ceiling-buried air conditioner according to Embodiment 2 of the present invention, in which FIG. 4(a) is a perspective view and FIG. 4(b) is a sectional view.

In FIG. 4, in a ceiling-buried air conditioner (hereinafter referred to as an “air conditioner”) 2000, the heat exchanger 100 (See Embodiment 1) is arranged. A motor 6 for driving a fan 5 is disposed on a central top-face side of a unit housing 4 of the air conditioner 2000, and a fan 5 is mounted on the motor 6 with its lower side as an inlet.

A bell mouth 7 for introducing the air into the fan 5 is arranged at a lower part of the fan 5. The heat exchanger 100 is arranged substantially annularly surrounding the fan, and a drain pan 9 is arranged below the heat exchanger 100. An opening portion connecting a secondary side of the heat exchanger 100 to the indoors is formed at each side of the drain pan 9 to communicate with an opening portion 10a of a decorative panel 10 and constitutes a blow-out port 8.

A vane 8v is mounted on the blow-out port 8 so that a blow-out direction can be adjusted. Also, a front panel 10c and a filter 10f are arranged below the fan 5 so as to be fitted in the center of the decorative panel 10.

The air conditioner 200 constituted as above is generally called “4-way cassette type”, in which a primary side of the fan is directed downward so as to suck air from the indoors. The sucked air passes through the filter 10f so that dusts are removed, and is blown to the heat exchanger 100. In the heat exchanger 100, heat exchange is performed between the air and the refrigerant, and the air to which heat is given or of which heat is deprived is blown out to the indoors through the blow-out port 8.

(Heat Transfer Performance and Ventilation Resistance)

Next, heat transfer performance and ventilation resistance of the heat exchanger 100 will be described below mainly on qualitative trends of shape parameters of the heat exchanger 100.

(Influence of Step Pitch Dp)

If the step pitch Dp is enlarged, a “fin efficiency” defined by a distance from an outer periphery of the heat transfer pipe 2 to an end portion of the plate fin 1 and a pipe diameter of the heat transfer pipe 2 is lowered, and a “pipe-outside heat-transfer coefficient” is lowered. Also, if the step pitch Dp is enlarged, the “ventilation resistance” is reduced, and an “increase in an air-amount” can be promoted.

On the other hand, if the step pitch Dp is reduced, the “fin efficiency” is increased and the “outside-pipe heat-transfer coefficient” is improved, but the “ventilation resistance” is increased.

(Influence of Row Pitch Lp)

If the row pitch Lp is enlarged, the “fin efficiency” is decreased and the “outside-pipe heat-transfer coefficient” is lowered, but since a heat transfer area is increased, heat transfer performance of the heat exchanger is improved. Also, the “ventilation resistance” is increased, and the air volume is lowered.

On the other hand, if the row pitch Lp is reduced, the “fin efficiency” is increased and the “outside-pipe heat-transfer coefficient” is improved, but since the heat transfer area is reduced, the heat transfer performance of the heat exchanger is lowered. Also, the “ventilation resistance” is reduced, and the “increase in air volume” can be promoted.

As mentioned above, the shape parameters of the heat exchanger has respective optimal values, and in order to quantitatively evaluate them, the heat transfer characteristics and the ventilation resistance of the heat exchanger are calculated by a method mentioned below.

A heat-transfer coefficient α [W/m2K] between the air and the plate fin is generally defined by the following equation:

α=Nu×λ/De Equation 1

Nu=C1×(Re×Pr×De/Lp/Ln)̂C2 Equation 2

Re=U×De/ν

Where Nu is Nusselt number,

Re is Reynolds number,

Pr is Prandt1 number,

λ is a heat-transfer coefficient of the air,

ν is a coefficient of dynamic viscosity of the air, and

C1 and C2 are constants.

In the case of normal temperature and the normal pressure, Pr=0.72, λ=0.0261 [W/mK], and λ is 0.000016 [m2/s].

Here, a representative length De [m] is defined by the following equation:

De=4×(Lp×Dp−π×D2/4)×Fp/{2×(Lp×Dp−π×D2/4)+π×D×Fp} Equation 3

A wind velocity U [m/s] of free-passage volumetric basis between the plate fins 1 and a front-face wind velocity Uf [m/s] of the heat exchanger are defined by the following equation:

U=Uf×Lp×Dp×Fp/{(Lp×Dp−π×D2/4)×Fp} Equation 4

Also, the fin efficiency η is defined by the following equation:

η=1/(1+φ×α) Equation 5

φ={(4×Lp×Dp/π)/2−D}2×(4×Lp×Dp/π)/2/D/2/6/Ft/λf Equation 6

Here, λf[w/m·k] is the heat-transfer coefficient of the plate fin.

On the other hand, the ventilation resistance “ΔP_hex[Pa]” between the air and the plate fin is defined by the following equation:

ΔP_hex=2×F×Lp×Ln×ρ×U2/De Equation 7

F=C3×De/Lp/Ln+C4×ReC5×(De/Lp/Ln)1+C5 Equation 8

Here, F is a friction loss coefficient, and C3, C4, and C5 are constants. Also, ρ is an air density and is approximately 1.2 [kg/m3] in the case of the normal temperature and the normal pressure.

(Blower Operating Power)

Also, in order to quantitatively evaluate the “blower operating power” when the heat exchanger 100 (Embodiment 1) is used in the air conditioner 200 (Embodiment 2), the blower operating power is calculated by the method shown below. The blower operating power Pf[W] is defined by the following equation:

Pf=ΔP_all×Q Equation 9-1

=(ΔP_hex+ΔP_etc)×Q Equation 9-2

The “ΔP_hex” is calculated below using the step pitch Dp and the row pitch Lp as parameters. A heat passage rate K of the heat exchanger is calculated by the following equation:

K=1/(1/αo+Ao/Ai/αi) Equation 11

αo=1/(Ao/(Ap+η×Af)/α) Equation 12

Ao=Ap+Af Equation 13

Where, K[W/m2K] is a total heat passage rate of the heat exchanger;

Ao[m2] is a total heat transfer area on the air side of the heat exchanger;

Ap[m2] is a pipe heat transfer area on the air side of the heat exchanger;

Af[m2] is a fin heat transfer area on the air side of the heat exchanger; and

Ai[m2] is a heat transfer area on the refrigerant side of the heat exchanger, and

if dimensions relying on the shape of the heat exchanger, that is, the step pitch Dp, the row pitch Lp, the fin pitch Fp, and the outer diameter D of the heat transfer pipe are determined, the values can be calculated. A heat transfer coefficient αi[W/M2K] of a fluid flowing through the pipe of the heat exchanger is supposed to be constant.

In general, a coefficient of performance COP of the air conditioner is defined by a ratio between a heat exchange amount and the total input, and by reducing the total input, the COP is improved, that is, energy is saved.

Next, the total input is obtained by adding a compressor input and the blower operating power Pf. The larger AoK, the less the compressor input, and the smaller the ΔP_hex, the less the blower operating power Pf.

Here, as a constant n, a heat exchange performance index “AoK/ΔP̂n” is defined. With regard to the constant n, supposing that it is “n=1” when a proportion of the ventilation resistance “ΔP_hex” to the total ventilation resistance is 100%, since the proportion to the total ventilation resistance in the heat exchanger 100 of the air conditioner 200 is approximately half, when ΔP_hex is twice, three times or four times, the total ventilation resistance becomes 1.5 times, 2.0 times or 2.5 times, respectively, which can be approximated by “n=0.59”.

Then, in the heat exchanger 100 of the air conditioner 200, the heat exchanger performance index is specified as “AoK/ΔP̂0.59” at the time of front-face wind velocity U=1 [m/s], and the relationships among the heat transfer pipe diameter D, the step pitch Dp, and the row pitch Lp were evaluated. In another air conditioner such as a room air-conditioner indoor unit, for example, since the proportion of ΔP_hex in the total ventilation resistance is approximately 80%, “n≈0.85”. The larger the value of n in the air conditioner form, the larger the influence of ΔP_hex on the heat exchanger performance index “AoK/ΔP̂n” becomes, and the heat exchanger 100 of the air conditioner 200 is characterized by a smaller influence of ΔP_hex as compared with the other air conditioners.

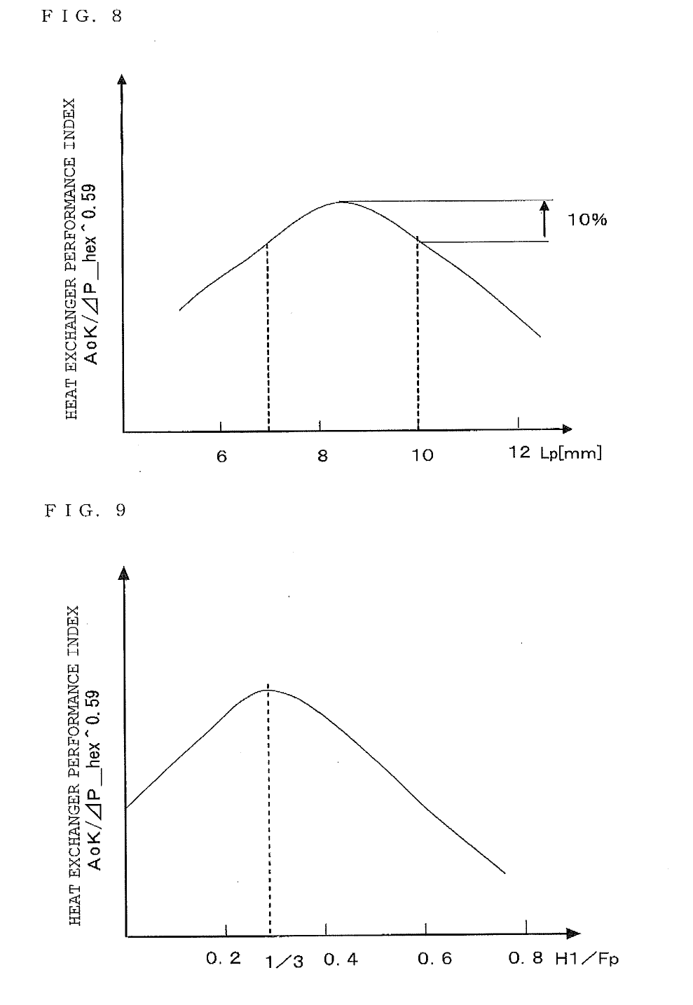

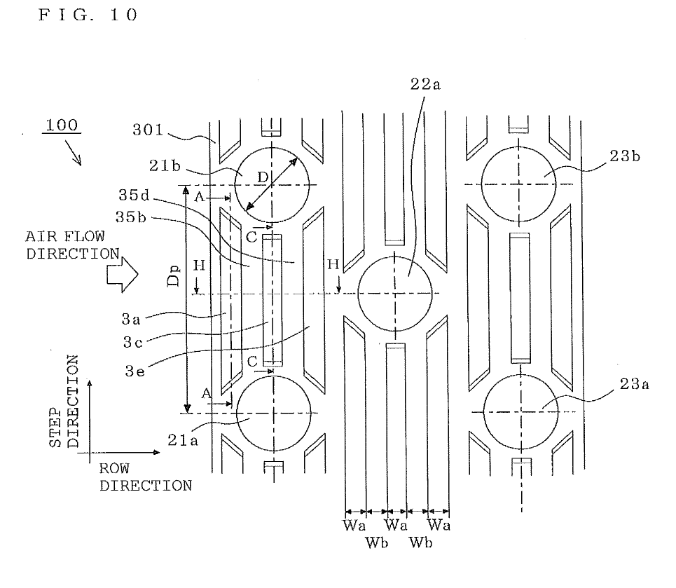

FIGS. 6 to 9 show an influence on the heat exchanger performance index “AoK/ΔP̂0.59” in the heat exchanger arranged in the ceiling-buried air conditioner according to Embodiment 1 of the present invention. FIG. 6 is a correlation diagram with the heat transfer pipe diameter D, FIG. 7 the step pitch Dp, FIG. 8 the row pitch Lp, and FIG. 9 the fin pitch Fp, respectively.

FIG. 6 is a result obtained by calculating the heat exchanger performance index “AoK/ΔP̂0.59” with the step pitch Dp=15.3 mm, the row pitch Lp=8.67 mm, and the front-face wind velocity U=1 [m/s], which are constant, and using the heat transfer pipe diameter D as a parameter.

When the heat transfer pipe diameter is 4 mm or less in view of manufacturing technique, work efficiency is extremely lowered in a process of inserting a pipe expanding rod into the heat transfer pipe and bringing it into close contact with the plate fin. On the other hand, when the heat transfer pipe diameter is 6 mm or more, “AoK/ΔP̂0.59” is extremely lowered, but within a range of D≦6 mm, the drop is 3% or less as compared with the heat transfer pipe diameter D=4 mm, so that a heat exchanger with sufficiently high heat transfer performance can be supplied.

Thus, the heat exchanger 100 with sufficiently high heat transfer performance without lowering manufacturing efficiency within the range of “4 mm≦D≦6 mm” can be supplied.

FIG. 7 is a result obtained by calculating the heat exchanger performance index “AoK/ΔP̂0.59” with the heat transfer pipe diameter 5 mm, the step pitch Lp=8.67 mm, and the front-face wind velocity U=1 [m/s], which are constant, and using the step pitch Dp as a parameter.

The heat exchanger performance index “AoK/ΔP̂0.59” shows the maximum value in the vicinity of the step pitch Dp=15 mm, and a drop is not more than 10% from the maximum value in “14 mm≦Dp≦17 mm”. When the step pitch Dp is 14 mm or less, since a bending pitch is small in a process of bending the heat transfer pipe into a hair-pin shape, there is a fear that the heat transfer pipe becomes a flat shape, which deteriorates appearance or incurs increase in pressure loss inside the pipe.

On the other hand, in the case of the step pitch Dp of 17 mm or more, supposing that an arrangement capacity of the heat exchanger is constant, the number of paths between the heat transfer pipes needs to be reduced, but if the number of paths is reduced, the increase in the pressure-loss inside the pipe deteriorates the performance of the heat exchanger. Particularly, the smaller the heat transfer pipe diameter, the more pressure loss inside the heat transfer pipe. Therefore, the step pitch Dp is preferably “14 mm≦Dp≦17 mm”.

FIG. 8 is a result obtained by calculating the heat exchanger performance index “AoK/ΔP̂0.59” with the heat transfer pipe diameter 5 mm, the step pitch 15.3 mm, and the front-face wind velocity U=1 [m/s], which are constant, and using the row pitch Lp as a parameter.

The heat exchanger performance index “AoK/ΔP̂0.59” shows the maximum value in the vicinity of the row pitch Lp=8 mm, and since a drop is not more than 10% from the maximum value in “7 mm≦Lp≦10 mm”, the heat exchanger 100 with sufficiently high heat transfer performance can be obtained.

If the row pitch Lp is 7 mm or less, it is difficult to form a fin collar (a hole through which the heat transfer pipe is inserted and a collar) on the plate fin in view of a manufacturing technique.

On the other hand, in the case of the row pitch Lp of 10 mm or more, the heat transfer rate K is lowered by a lowered fin efficiency and in addition, increase in the ventilation resistance ΔP remarkably reduces the heat exchanger performance index “AoK/ΔP̂0.59”. Therefore, the row pitch is preferably “7 mm≦Lp≦10 mm”.

FIG. 9 is a result obtained by calculating the heat exchanger performance index “AoK/ΔP̂0.59” with the heat transfer pipe diameter 5 mm, the step pitch 15.3 mm, the row pitch LP of 8.67 mm, and the front-face wind velocity U=1 m[m/s], which are constant, and using the ratio “H1/Fp” between a height H1 of cutting and raising and a fin pitch Fp as a parameter.

An air flow passage is formed with an equal interval between a base portion and the cutting and raising of the plate fin in the vicinity of the ratio “H1/Fp=⅓” between the height H1 of the cutting and raising and the fin pitch Fp, and the heat transfer can be improved to the highest efficiency, and the heat exchanger performance index “AoK/ΔP̂ 0.59” shows the maximum value, and the heat exchanger 100 with sufficiently high heat transfer performance can be obtained.

### Embodiment 3

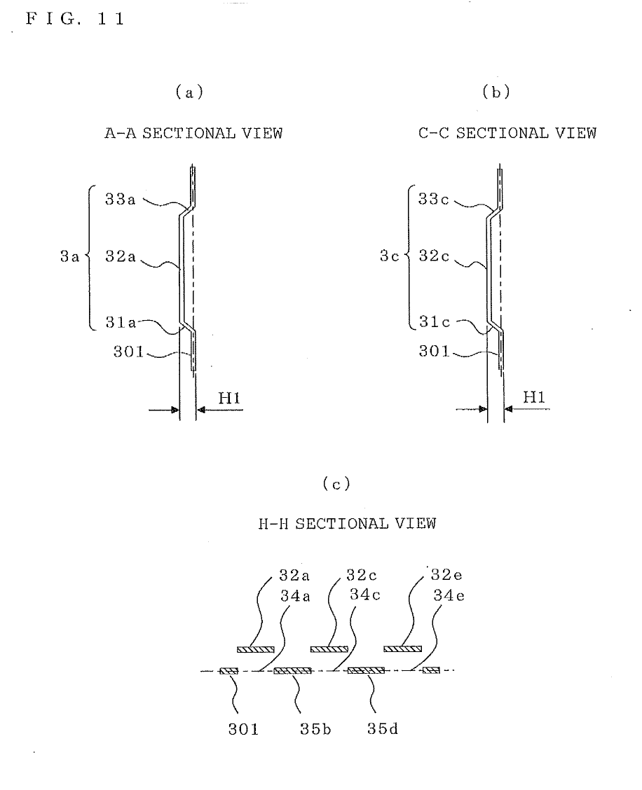

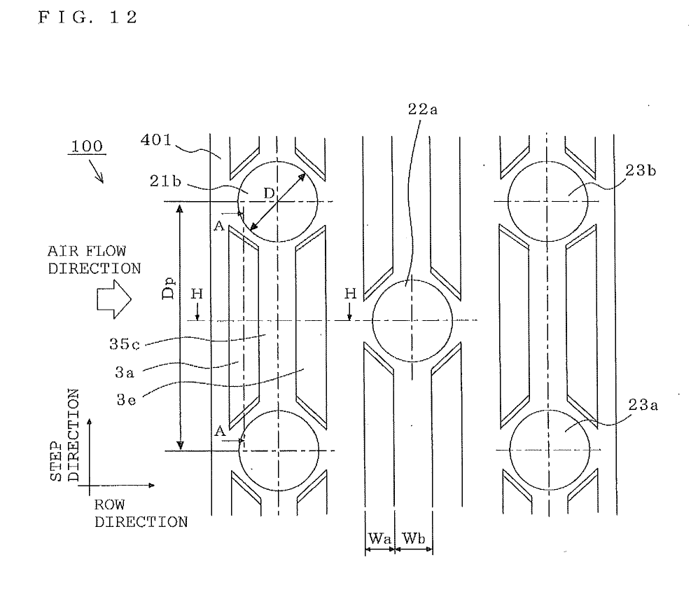

FIGS. 10 and 11 explain a heat exchanger arranged in a ceiling-buried air conditioner according to Embodiment 3 of the present invention. FIG. 10 is a plan view illustrating a portion. FIG. 11 is a sectional view on front. The same reference numerals are given to the same portions as those in Embodiment 1 and a part of the explanation will be omitted. For those referring to the common contents, description of suffixes “a, b, c, . . . ” will be omitted in the explanation.

(Plate Fin)

In FIGS. 10 and 11, a plate fin 301 is a rectangular plate material and a plurality of through holes through which the straight pipe portion 2s of the heat transfer pipe 2 penetrates are formed in a zigzag state.

Moreover, the first slit fins 3a, 3c, 3e protruding to the side of one of the faces are formed between the strait pipe portion 21a and the straight pipe portion 21b. That is, the plate fin 301 is equal to the plate fin 1 (Embodiment 1) from which the second slit fins 3b and 3d are removed (not cut and raised).

Therefore, between the first slit fin 3a and the first slit fin 3c, a plate-fin strip portion 35b, which is a part of the plate fin 301 is disposed, and between the first slit fin 3c and the first slit fin 3e, a plate-fin strip portion 35d, which is a part of the plate fin 301, is disposed, respectively.

Widths of the first slit fins 3a, 3c, 3e in the air flow direction (referred to as “Wa” for convenience) are the same and widths of the plate fin strip portions 35b, 35d in the air flow direction (referred to as “Wb” for convenience) are the same.

As mentioned above, even when the three first slit fins 3a, 3c, 3e are cut and raised in the row direction, the effect of the present invention can be obtained as in Embodiment 1.

### Embodiment 4

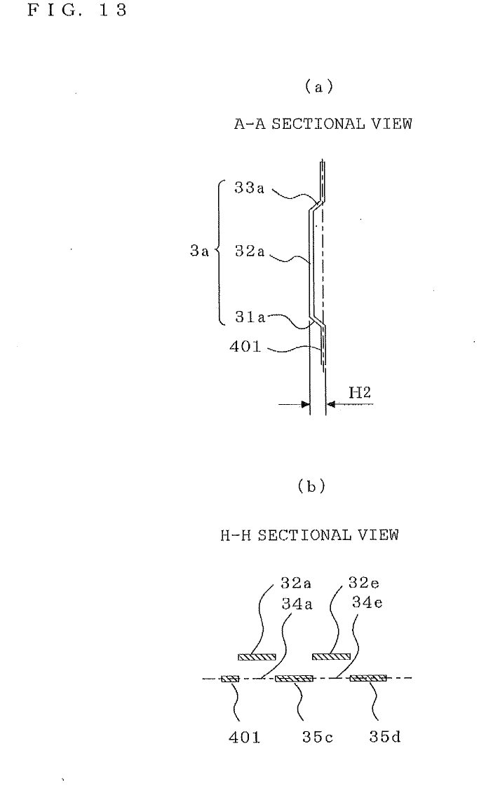

FIGS. 12 and 13 explain a heat exchanger arranged in a ceiling-buried air conditioner according to Embodiment 4 of the present invention. FIG. 12 is a plan view illustrating a portion. FIG. 13 is a sectional view. The same reference numerals are given to the same portions as those in Embodiment 1 and a part of the explanation will be omitted. For those referring to the common contents, description of suffixes “a, b, c, . . . ” will be omitted in the explanation.

(Plate Fin)

In FIGS. 12 and 13, a plate fin 401 is equivalent to the plate fin 301 (Embodiment 3) from which the first slit fin 3c is removed (not cut and raised).

Therefore, between the straight pipe portion 21a and the straight pipe portion 21b, the two first slit fins 3a, 3e are formed in the row direction protruding to the side of one of the faces. Between the first slit fin 3a and the first list fin 3e, a plate-fin strip portion 35c, which is a part of the plate fin 301, is disposed.

Widths of the first slit fins 3a, 3e in the air flow direction (referred to as “Wa” for convenience) are the same and width of the plate-fin strip portion 35c in the air flow direction is referred, to as “Wb” for convenience.

As mentioned above, even when the two first slit fins 3a, 3e are cut and raised in the row direction, the effect of the present invention can be obtained similarly to Embodiment 1.

[Effect of Slit Fin]

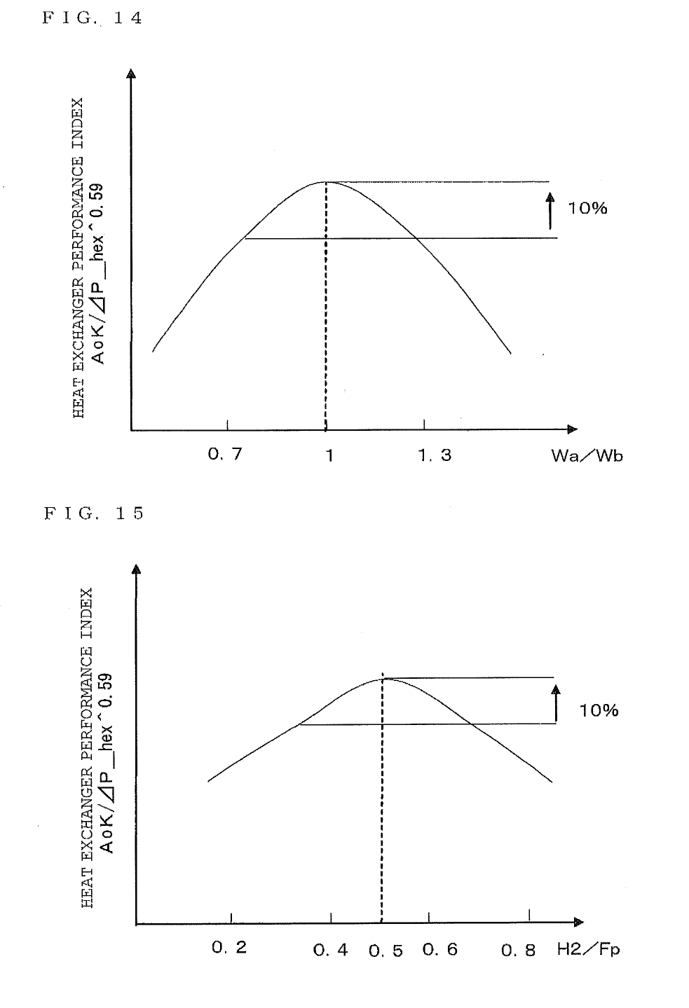

FIGS. 14 and 15 are correlation diagrams for explaining the effect of the slit fin in the heat exchanger shown in FIGS. 12 and 13.

In FIG. 14, the horizontal axis indicates a ratio “wa/wb” between a width wa of the slit fin 3a or the like in the row direction and a width wb of the plate-fin strip portion 35b or the like in the row direction disposed between the slit fins, and the vertical axis indicates the heat exchanger performance index “AoK/ΔP_hex̂ 0.59”, calculation results using the former as a parameter.

From FIG. 14, when the ratio “wa/wb” is 1, that is, “Wa:Wb=1:1, Wa=Wb”, the heat exchanger with the sufficiently large heat exchanger performance index “AoK/ΔP_hex̂ 0.59” can be obtained.

In FIG. 15, the horizontal axis indicates “H2/Fp”, which is a height H2 of the slit fin 3a or the like made dimensionless by the fin pitch Fp, and the vertical axis indicates the heat exchanger performance index “AoK/ΔP_hex̂ 0.59”, calculation results using the former as a parameter. From FIG. 15, when the slit fin height H2 is ½ of the fin pitch Fp, the heat exchanger with the sufficiently high heat exchanger performance index “AoK/ΔP_hex̂ 0.59” can be obtained.

### Embodiment 5

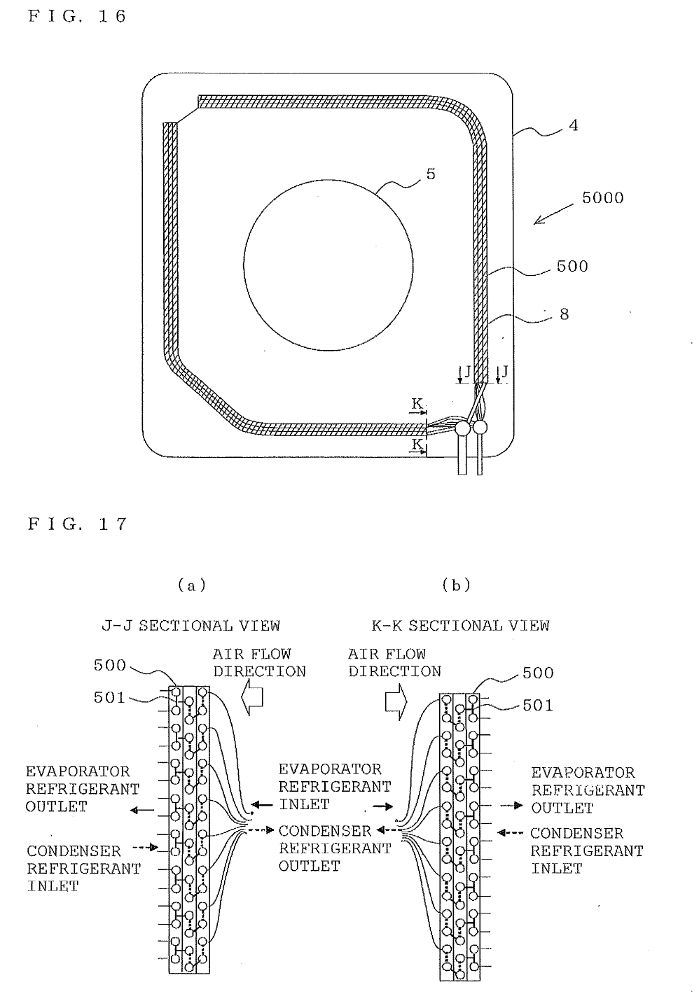

FIGS. 16 and 17 explain a concept of a ceiling-buried air conditioner according to Embodiment 5 of the present invention. FIG. 16 is a bottom view. FIG. 17 is a partially sectional view.

In FIGS. 16 and 17, a heat exchanger 500 is arranged in a ceiling-buried air conditioner (hereinafter referred to as an “air conditioner”) 5000. The same reference numerals are given to the same portions as those in FIG. 4 (Embodiment 2) and FIG. 1 (Embodiment 1) and a part of the explanation will be omitted, and for those referring to the common contents, description of suffixes “a, b, . . . ” will be omitted in the explanation.

In FIG. 16, the fan 5 is mounted on the central top face side of the unit housing 4 of the air conditioner 5000 with the lower side as an inlet. Two units of the heat exchangers 500 bent in the L-shape so as to surround the fan 5 are arranged substantially annularly.

As mentioned above, by arranging two units of the L-shaped heat exchangers 500 substantially annularly, a length in which the refrigerant passes through the heat transfer pipe 2 can be reduced as compared with the substantially annular arrangement of only one unit of the heat exchanger in the square shape, and the number of paths is doubled. Thus, the intra-pipe pressure loss of the refrigerant can be reduced. This is extremely effective means in reducing the diameter of the heat transfer pipe 2.

Therefore, when the heat exchanger 500 is to be used as an evaporator, the refrigerant flows in 16 paths from an evaporator refrigerant inlet direction shown in FIGS. 16 and 17, distributed into 32 paths by a T-shaped three-way pipe 501 between the second row and the third row with respect to the air flow direction and flows out to an outlet.

When the refrigerant flows through the heat transfer pipe of the heat exchanger of the evaporator in general, a state of the refrigerant is changed in order of a two-phase region and an overheated gas. The pressure loss “ΔP_ref” of the refrigerant at that time is larger in the overheated gas than in the two-phase region. In the present invention, by an effect that the number of paths is increased from 16 paths to 36 paths between the second row and the third row in the vicinity of an evaporator outlet, the pressure loss “ΔP_ref” of the refrigerant can be extremely reduced. This is extremely effective means when the diameter of the heat transfer pipe 2 is reduced.

When the heat exchanger 500 is used as a condenser, the refrigerant flows in 32 paths from a condenser refrigerator inlet direction shown by FIG. 16, merged by the T-shaped three-way pipe of the second and third row pipes with respect to the air flow direction into 16 paths and flows out to the outlet.

### INDUSTRIAL APPLICABILITY

According to the present invention, since the heat transfer performance is high, a wide utilization is possible as various types of in-storage heat exchanger and various types of ceiling-buried air conditioner equipped therewith.

### DESCRIPTIONS OF CODES AND SYMBOLS

1 plate fin
2 heat transfer pipe
2r curved pipe portion
2s straight pipe portion
3 slit fin
3a first slit fin
3b second slit fin
3c first slit fin
3d second slit fin
3e first slit fin
4 unit housing
5 fan
6 motor
7 bell mouth
8 blow-out port
8v vane
9 drain pan
10 decorative panel
10a opening portion
10c front panel
10f filter
21a straight pipe portion
21b straight pipe portion
21c straight pipe portion
22a straight pipe portion
23a straight pipe portion
31a first slit fin slope
31b second slit fin slope
32a first slit fin plane
32b second slit fin plane
33a first slit fin slope
33b second slit fin slope
34a first slit fin groove
34b second slit fin groove
34c first slit fin groove
34d second slit fin groove
34e first slit fin groove
35b plate fin strip portion
35c plate fin strip portion
35d plate fin strip portion
100 heat exchanger
200 air conditioner
2000 ceiling-buried air conditioner
301 plate fin
401 plate fin
500 heat exchanger
5000 ceiling-buried air conditioner
ΔP ventilation resistance
α heat transfer coefficient
αi heat transfer coefficient
η fin efficiency
Ao air-side total heat transfer area
AoK/ΔP_hex̂ 0.59 heat exchanger performance index
D outer diameter
De representative length
Dn number of steps
Dp step pitch
Fp fin pitch
H1 height
H2 height
K heat passage rate
Lp row pitch
Pf fan operating power
Pf blower operating power
Q air flow-rate
Rp row pitch
U wind velocity
Uf front-face wind velocity
wa width (width of slit fin in row direction)
wb width (width of plate fin strip portion in row direction)

1. A heat exchanger for a ceiling-buried air conditioner, comprising:
a plurality of plate fins laminated in parallel with each other at a predetermined interval so that a gas passes through said interval and a heat transfer pipe penetrating while meandering through the plate fins and through which a working fluid passes, wherein
relationships among an outer diameter (D) of said heat transfer pipe, a step pitch (Dp), which is a distance between coaxial cores of said heat transfer pipe in a step direction orthogonal to a gas passing direction, and a row pitch (Lp), which is a distance between coaxial cores of said heat transfer pipe in a row direction, which is a gas passing direction, are:
4 mm≦D≦6 mm
14 mm≦Dp≦17 mm
7 mm≦Lp≦10 mm.

2. A heat exchanger for a ceiling-buried air conditioner, comprising:
a plurality of plate fins laminated in parallel with each other at a predetermined interval so that a gas passes through said interval; a heat transfer pipe penetrating while meandering through the plate fins and through which a working fluid passes;
a first slit fin cut and raised in parallel with an orthogonal direction of a gas passing direction and protruding to the side of one of faces of said plate fin; and
a second slit fin cut and raised in parallel with the first slit fin and protruding to the side of the other face of said plate fin, wherein
a first slit groove, which is a trace of said first slit fin, which has been cut and raised, and a second slit groove, which is a cut and raised trace of said second slit fin, continue each other.

3. The heat exchanger for a ceiling-buried air conditioner of claim 2, wherein
a protruding height (H1) of said first slit fin from one face of said plate fin and a protruding height (H2) of said second slit fin from the other face of said plate fin are ⅓ of a fin pitch (Fp), which is a planar interval of said plate fin (H1=Fp/3, H2=Fp/3).

4. A heat exchanger for a ceiling-buried air conditioner, comprising:
a plurality of plate fins laminated in parallel with each other at a predetermined interval so that a gas passes through said interval; a heat transfer pipe penetrating while meandering through the plate fins and through which a working fluid passes; and
a plurality of slit fins cut and raised in parallel with an orthogonal direction of a gas passing direction and protruding to the side of one face of said plate fin, wherein
a width (Wa) of said slit fin in the gas passing direction and an interval (Wb) in the gas passing direction between slit grooves, which are cut and raised traces of said slit fins, are equal.

5. The heat exchanger for a ceiling-buried air conditioner of claim 4, wherein
a protruding height (H) of said slit fin from one of faces of said plate fin is ½ of the fin pitch (Fp), which is a planar interval of said plate fin (H=Fp/2).

6. The heat exchanger for a ceiling-buried air conditioner of claim 1, wherein
said heat transfer pipe is formed by a plurality of straight pipe portions and a plurality of curved pipe portions communicating with the straight pipe portions; and
said straight pipe portions are arranged in a zigzag state so as to form three rows with respect to a gas passing direction.

7. A ceiling-buried air conditioner comprising:
a housing,
a fan arranged at the center of the housing for discharging air sucked from a lower part of the housing laterally, and
two units of heat exchangers of claim 1 arranged so as to surround the fan, wherein
said straight pipe portions of the heat transfer pipe constituting said heat exchanger are bent in an L-shape.

8. The ceiling-buried air conditioner of claim 7, wherein
when the heat exchanger is used as an evaporator, a piping path is provided so that after the refrigerant is made to flow in 16 paths, the refrigerant is made to flow out in 32 paths by using a T-shaped three-way pipe.

9. A ceiling-buried air conditioner having a refrigerant as a working fluid and provided with a compressor, a throttle device, a condensation heat exchanger, and an evaporation heat exchanger, wherein
either or both of said condensation heat exchanger or said evaporation heat exchanger use the heat exchanger of claim 1.

10. The ceiling-buried air conditioner of claim 9, wherein
any of R407C, R410A, R32, isobutane, carbon dioxide, or ammonia is used as said refrigerant.

11. The heat exchanger for a ceiling-buried air conditioner of claim 2, wherein
said heat transfer pipe is formed by a plurality of straight pipe portions and a plurality of curved pipe portions communicating with the straight pipe portions; and
said straight pipe portions are arranged in a zigzag state so as to form three rows with respect to a gas passing direction.

12. The heat exchanger for a ceiling-buried air conditioner of claim 4, wherein
said heat transfer pipe is formed by a plurality of straight pipe portions and a plurality of curved pipe portions communicating with the straight pipe portions; and
said straight pipe portions are arranged in a zigzag state so as to form three rows with respect to a gas passing direction.

13. A ceiling-buried air conditioner comprising:
a housing,
a fan arranged at the center of the housing for discharging air sucked from a lower part of the housing laterally, and
two units of heat exchangers of claim 2 arranged so as to surround the fan, wherein
said straight pipe portions of the heat transfer pipe constituting said heat exchanger are bent in an L-shape.

14. A ceiling-buried air conditioner comprising:
a housing,
a fan arranged at the center of the housing for discharging air sucked from a lower part of the housing laterally, and
two units of heat exchangers of claim 4 arranged so as to surround the fan, wherein
said straight pipe portions of the heat transfer pipe constituting said heat exchanger are bent in an L-shape.

15. The ceiling-buried air conditioner of claim 13, wherein
when the heat exchanger is used as an evaporator, a piping path is provided so that after the refrigerant is made to flow in 16 paths, the refrigerant is made to flow out in 32 paths by using a T-shaped three-way pipe.

16. The ceiling-buried air conditioner of claim 14, wherein
when the heat exchanger is used as an evaporator, a piping path is provided so that after the refrigerant is made to flow in 16 paths, the refrigerant is made to flow out in 32 paths by using a T-shaped three-way pipe.

17. A ceiling-buried air conditioner having a refrigerant as a working fluid and provided with a compressor, a throttle device, a condensation heat exchanger, and an evaporation heat exchanger, wherein
either or both of said condensation heat exchanger or said evaporation heat exchanger use the heat exchanger of claim 2.

18. A ceiling-buried air conditioner having a refrigerant as a working fluid and provided with a compressor, a throttle device, a condensation heat exchanger, and an evaporation heat exchanger, wherein
either or both of said condensation heat exchanger or said evaporation heat exchanger use the heat exchanger of claim 4.

19. The ceiling-buried air conditioner of claim 17, wherein
any of R407C, R410A, R32, isobutane, carbon dioxide, or ammonia is used as said refrigerant.

20. The ceiling-buried air conditioner of claim 18, wherein
any of R407C, R410A, R32, isobutane, carbon dioxide, or ammonia is used as said refrigerant.
